(19) United States
(12) Patent Application Publication
(10) Pub. No.: US 2014/0114769 A1
(43) Pub. Date: Apr. 24, 2014

(54) Digital Memories for Advertising

(71) Applicant: YAHOO! INC., Sunnyvale, CA (US)

(72) Inventor: Laura Chaibi, London (GB)

(73) Assignee: YAHOO! INC., SUNNYVALE, CA (US)

(21) Appl. No.: 13/654,582

(22) Filed: Oct. 18, 2012

(51) Int. Cl. G06Q 30/02

(52) U.S. Cl. CPC G06Q 30/0269
USPC 705/14.66

(57) ABSTRACT

A method for digital advertising includes steps or acts of: using a memory device with computer-executable instructions stored therein, the instructions including: accessing a profile identifying a user, the profile providing the user's preferences for interaction with digital advertisements; receiving a selection of a digital advertisement viewed by the user; and storing at least a portion of the digital advertisement in a digital ad repository linked with the user's profile, the storing being executed according to the user's preferences. The method further includes using a processor device operably coupled with the memory device for executing the computer-executable instructions from memory.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of digital advertising, and more particularly relates to the field of digital memory-based advertising.

### BACKGROUND OF THE INVENTION

In today's world, there is tremendous competition for our attention. We live in a digital age that abounds with information sources and communication mediums. In order to deal with the information overload, people have a tendency to filter the information most relevant information to them right now, and not pay attention to the rest. Furthermore, with loads of appointments and commitments amid various distractions and interruptions, people rely upon a variety of memory aids for their day-to-day business, increasingly relying on digital aids to help cope with information and memory demands.

Many of us rely 100% on technology to manage memory in this area of our lives. As one person said . . . “I know I stopped remembering in 1995; it was the time I got my first mobile phone and it all went downhill from there. If I knew you before then I could remember your phone number, your birthday and address, now I can't remember anything . . . .” Email appears to be the digital dumping ground for what we cannot keep in our head and what we no longer record on paper. We are increasingly relying on email for what we want to remember and mobiles for what we do not want to forget. For example, some memory aids are PC/Mobile Device calendar reminders, mobile alerts, email/SMS sent to self, Facebook reminders, calendar events, post-it notes, paper calendar/diaries, and the like. We handle this by focusing on what we can deal with now and shunting everything else into the future. Technology has exacerbated the situation as well as given us tools to cope with the information overload.

With all this noise and ad clutter it is harder for advertisers to get their message through. With such scarcity of attention and the lack of people's ability to remember their important commitments (without an aid), it is difficult for digital ads to get people's attention and be remembered by them. An important observation is that out of about 20,000 ad campaigns over a week, users remember only 20 brands. Consumers want greater leeway in interacting with ads and better techniques to aid digital remembering. Advertisers want their ads to be remembered.

To exacerbate the situation for digital advertising, digital ads run counter to how we run everything else in our lives. In our busy lives, we tend to employ the “send to the future/park it/come back later” model. For example, we'll send ourselves email reminders with screen grabs. In contrast, digital ads follow the “click now or lose it for good” model. After we have seen the ad, there is no fool-proof way of locating the information again. Many users resort to using search—text, image and video searching for ads they have seen, but can't remember. And advertisers are finding it harder to “attribute” what part of their communications are most effective: search, display, targeted ads, email or affiliate programs, and “network buys,” for example.

Another issue with search is having to sift through too many results, making it nearly impossible to connect with the unique information that caught our interest in the first place. This frustration is generating a barrier to engagement. If users can't find it, keep it, or action it, they are extremely limited in their ability to engage with the message intent, which in many cases is to encourage purchase of a product. We have to employ coping strategies which are failing us.

We need a better way to empower consumers with ways to remember ads and push them into the future so they can come back to the ad at a more convenient time. This is crucial because unless an ad is so important it can't be forgotten, consumers assume they can find the ad again, resulting in a disconnect between advertiser opportunity and consumer enablement.

### SUMMARY OF THE INVENTION

Briefly, according to an embodiment of the invention a method for digital advertising includes steps or acts of: using a memory device with computer-executable instructions stored therein, the instructions including: accessing a profile identifying a user, the profile providing the user's preferences for interaction with digital advertisements; receiving a selection of a digital advertisement viewed by the user; and storing at least a portion of the digital advertisement in an digital ad repository linked with the user's profile, the storing being executed according to the user's preferences. The method further includes using a processor device operably coupled with the memory device for executing the computer-executable instructions from memory.

According to another embodiment of the present invention, an information processing system for digital advertising includes a memory device with computer-executable instructions stored therein; and a processor device operably coupled with the memory. The processor device executes the following instructions from memory: accessing a profile identifying a user, the profile providing the user's preferences for interaction with digital advertisements; receiving a selection of a digital advertisement viewed by the user; and storing at least a portion of the digital advertisement in a digital ad repository linked with the user's profile, the storing being executed according to the user's preferences.

According to another embodiment of the present invention, a computer program product includes a non-transitory computer-readable storage medium with computer-executable instructions stored therein. The computer-executable instructions include: accessing a profile identifying a user, the profile providing the user's preferences for interaction with digital advertisements; receiving a selection of an digital advertisement viewed by the user; and storing at least a portion of the digital advertisement in an digital ad repository linked with the user's profile, the storing being executed according to the user's preferences.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a high level diagram showing a user scenario of a method according to an embodiment of the present invention;

FIG. 2 is an example advertisement for OpenID, according to the known art;

FIG. 3 is a high-level flowchart of the method for digital memory-backed advertisement, according to an embodiment of the present invention;

FIG. 4 is a flowchart of a method for saving advertisements, according to an embodiment of the present invention;

FIG. 5 is a flowchart of another method for saving advertisements, an information processing system configured to operate according to an embodiment of the present invention;

FIG. 6 is an exemplary advertisement showing user-selectable memory icons, according to an embodiment of the present invention;

FIG. 7 is an exemplary user profile, according to an embodiment of the present invention;

FIG. 8 is an example of the drag-and-capture feature, according to an embodiment of the present invention;

FIG. 9 is an exemplary illustration of a carousel for multiple stored ads, and/or classifications of storage, according to an embodiment of the present invention;

FIG. 10 is a high-level block diagram of an information processing system configured to operate according to an embodiment of the present invention;

FIG. 11A is an exemplary illustration of a profile selection screen, according to an embodiment of the present invention;

FIG. 11B is an exemplary illustration of a next profile selection screen, according to an embodiment of the present invention;

FIG. 12A is an exemplary illustration of the interaction button on a mobile device, used for saving an advertisement in an ad network, according to an embodiment of the present invention;

FIG. 12B is an exemplary illustration of the expanded interaction button of FIG. 12A, according to an embodiment of the present invention;

FIG. 12C is an exemplary illustration of an expanded shopping cart interaction button, according to an embodiment of the present invention;

FIG. 13 is an exemplary illustration of a user-specified query associated with an ad, according to an embodiment of the present invention;

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe a novel advertising paradigm which enables users to save the products (or features of the products) featured in advertisements (ads), or the ad itself, for future view/action. We provide the ability to turn a moment of interest into future attention.

Specifically, we propose methods to use digital memory for storing and retrieving the ads themselves and/or the advertised products in an ad repository operably connected with the individual's digital profile. By saving the ads, the users can retrieve the saved ads later and interact with them (explore more about the advertised products, or take desired actions) at their convenience. This prevents the frustration that users experience due to the lack of time to interact with ads when the ads are initially shown to them, or due to the waste of their time searching for lost ads afterwards. With digital memory ad retrieval ability, this also brings more user attention and focus on the ads, along with increased user interaction. This results in better ad campaign effectiveness.

Digital Memories System 100.

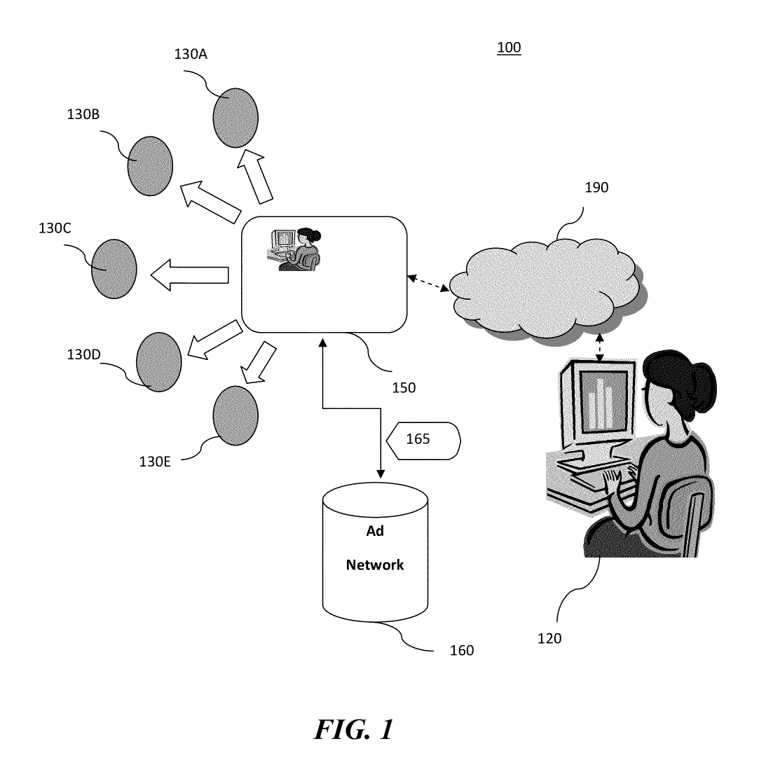

Referring now to the drawings and to FIG. 1 in particular, we show a digital memories scenario 100 according to an embodiment of the present invention. A user 120 accesses the Internet 190. For simplicity we show a desktop computer. Those with knowledge in the art will appreciate that the method presented here is device agnostic; any device with a capability to access digital information can be used, within the spirit and scope of the invention.

For example, we contemplate using: a tablet computer, mobile phone, e-book device, or any device with Internet connectivity such as an Internet-enabled television, white (electronic) goods such as refrigerators or digitally enhanced household furniture and fixtures (kitchen countertop), transport vehicles with digital storage and retrieval technologies (such as GPS, or media storage) as well as appliances or machines that can encompass storing advertising messages in some capacity and can be implemented according to embodiments of the invention.

As an example, kitchen appliances and white (electronic) goods such as refrigerators will soon have (or already have) the ability to store digital shopping lists. You will be able to see an ad for cereal and add that item to your shopping list which lives digitally on your fridge. Equally, a location related to where something can be bought that is listed in an ad could be sent to the GPS (global positioning system) in your car. Or for example, if you see an ad on how to make something with vegetable stock cubes, the recipe can be sent to your kitchen counter top or wall with a digital touch screen device built into it/beamed onto it.

Returning now to FIG. 1, the user 120 sets up a digital user profile 150 that includes the user's preferences, to be discussed later. Alternatively, the user 120 is able to forgo the process of setting a profile 150 and rely instead on pre-defined default settings. Associated with the user profile 150, each user 120 can have a private ad repository 160 to which he/she can add new ads 165. These new ads 165 can be from any digital source such as a website, a digital application, and a program which he/she can also access from anywhere on the Internet 190 where the user profile 150 is recognized.

User Profile 150.

Using this user profile 150 the user 120 is able to identify himself/herself at locations 130A through 130E. These locations 130A through 130E may be websites, Internet-enabled TV, or any other medium displaying digital information and commercial messaging. Additionally, the user profile 150 contains the user's preferences in dealing with ads 165 and the products they represent. Any advertising on those locations 130A through 130E that the user 120 wishes to retain can be stored in the ad repository 160, depending on the user's preferences. The user 120 can simply drag and drop the ad 165 into his/her repository 160 or another mechanism for saving the ad 165 can be initiated. At a later time the user 120 can access the stored ads 165 from the repository 160, or from the locations where they have opted to store the ads 165, such as their electronic calendar.

The user 120 as administrator sets up the repository 160 according to his/her preferences. Additionally, the user 120 as administrator is able to set the digital information stored in the repository for sharing. For example, six people planning a holiday can access/share/transfer saved ads to a communal repository. The stored digital information can be set to public or private at the administrator's preference.

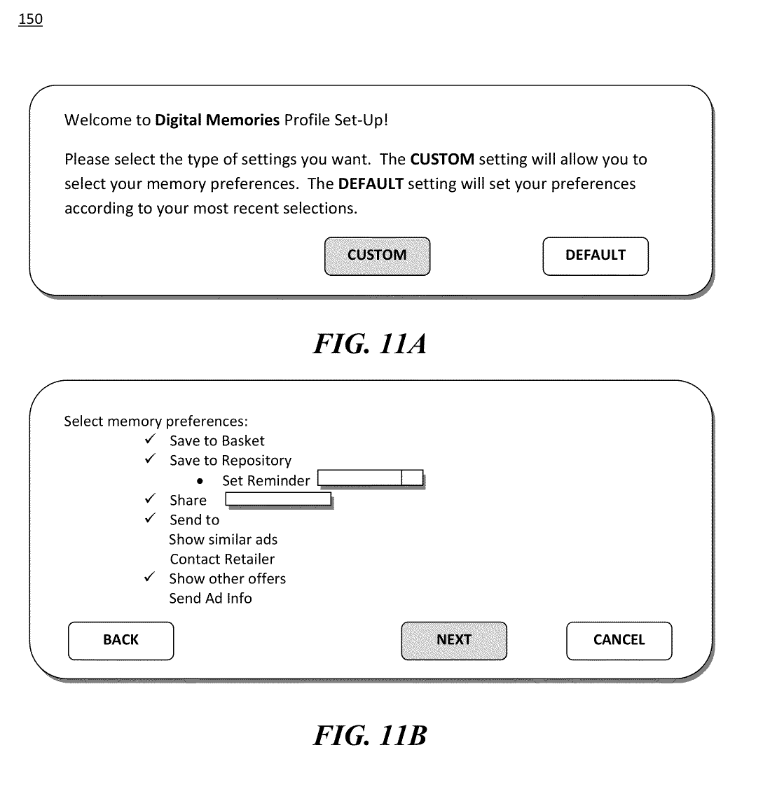

Two exemplary profile selection screens are shown in FIGS. 11A and 11B. In one embodiment, the user 120 right-clicks on the ad or selects an expand button, and is presented with a drop-down menu of options such as “Save Ad,” “Place in Basket,” and the like. The user 120 may select to save the advertised item(s) to a shopping cart at preferred sellers by selecting the cart option 431. With this option 431 the user 120 does not retrieve the ad itself, but instead adds the product to a shopping basket. Note that retrieval of the ad 165 is the reverse of saving the ad 165. If the advertiser places the product from the basket into a shopping cart, the user 120 can retrieve the product from the shopping cart. The user 120 may opt to have the advertiser send information about the product and/or retailer, such as the closest location to buy the advertised product, by selecting the option 438. Or, the user 120 may elect to have this information provided via SMS, email or social networking service. In accordance with the items above that the user 120 might want to store, equally important is the consideration of the method for storage and retrieval. The user 120 might want to:

“send to self”—the user 120 elects to have the ad transmitted to him/herself at another location for its retrieval such as but not limited to email, another website with storage and retrieval capability, an application, a device or digitally enabled item which can receive the transferred material.

“saved search”—find-ability of further information associated with one ad is difficult. To ensure that the user 120 goes directly to the associated location in the digital universe, the user 120 can create a bespoke query string attached to the ad 165 and have this value saved to be used as a search query. The retrieval of the saved user-defined value will produce the most relevant material associated with the ad 165.

An example might be an ad from a retailer that promotes ⅓ off fragrances. The user 120 might want to save a value formulated as ‘Ella's birthday present’ and three weeks later retrieve the saved value to locate the item to which the ad 165 refers. Currently, if the user 120 inputs a search query for ⅓ off fragrances into a search engine, the results generated are well over five million.

Allowing the user 120 to apply the meaning of the saved search ensures that the user 120 is directly linked back to the right and intended message that captured the user's attention. The user 120 may elect to save/send a thumbnail of the ad, an alphanumeric string, or any other memory aid. Whatever the format of the value that is saved, it can be applied to several saved items such as “Ella's birthday present” so all saved items will populate results in a search query framework with links being related to the location of the saved items.

“notify me”—set a Bluetooth-enabled or radio wave/digital spectrum enabled reminder that alerts the user 120 when the user's device is near a location where the product is featured (such as a shop). This functionality supports the ability for the user 120 to say for example ‘notify me’ when I am close to a shop that sells the product advertised. An example might be an offer message that says ‘our flowers last 2 weeks guaranteed’ and the option to digitally remember this is to receive an alert when you are passing a flower shop that has made this guarantee—reminding you that you might want to further explore this promise in the shop.

“Call back”—this allows and gives the brand in question the ability to contact the user 120. An example might be that your car insurance is up for renewal and you see an ad promoting car insurance. The user 120 might want the brand to call them between 7-9 pm the next day to discuss a quote. This functionality needs to support the ability for the user 120 to supply his/her number, most likely already set up in the user profile 150 as well as refer to a specific time. This would support businesses' ability to better manage call centre resources, lead generation and staffing.

“sampling”—in the user 120's profile he/she has the option to also populate fields with his/her home address which allows upon permission, the advertiser to send samples of products via post. When the user 120 selects ‘send a sample’ or the sample icon, the user's address should auto-complete, allowing a moment for editing and then be sent to the advertiser. With so much need for permission-based marketing, this allows brands the ability to send samples to those exposed to an ad as well as receive permission to contact them by post.

“calendar reminder”—the user 120 can add a reminder to a digital calendar to remind him/her about the ad 165. For example there may be a time-based offer: sale starts Friday, tickets go on sale 8 am tomorrow, 48 hour sales starts this weekend etc. . . . and the user 120 will be able to save the ad 165 in an electronic calendar for when he/she wants to be reminded. The calendar may be on the user's mobile, in his/her email, on a social networking site, or any device agnostic electronic calendar that can receive the intended materials to be digitally remembered.

“to do list/shopping list/wish list/electronic post-it note”—keeping in the spirit that the user 120 is not restricted to saving paid media messages in media environments, a digital ‘list or note’ relating to a media message might be stored and retrieved from traditional digital media websites, programs or the like as well as on other digitally enabled machines, devices, electronics items, vehicles or fixtures such as vehicles, refrigerators, household countertops or any material that is digitally enabled to store and retrieve such information.

“save coupon for redemption”—the user 120 might wish to retain the advertising message or offer in the form of a coupon for redemption. This may include but is not limited to an electronic code, e-voucher, coupon, QR (quick response) code, special password or special redemption reference unique to the user 120 that the user 120 wishes to save or send elsewhere for retrieval, much like other methods mentioned in the spirit and the scope of the invention.

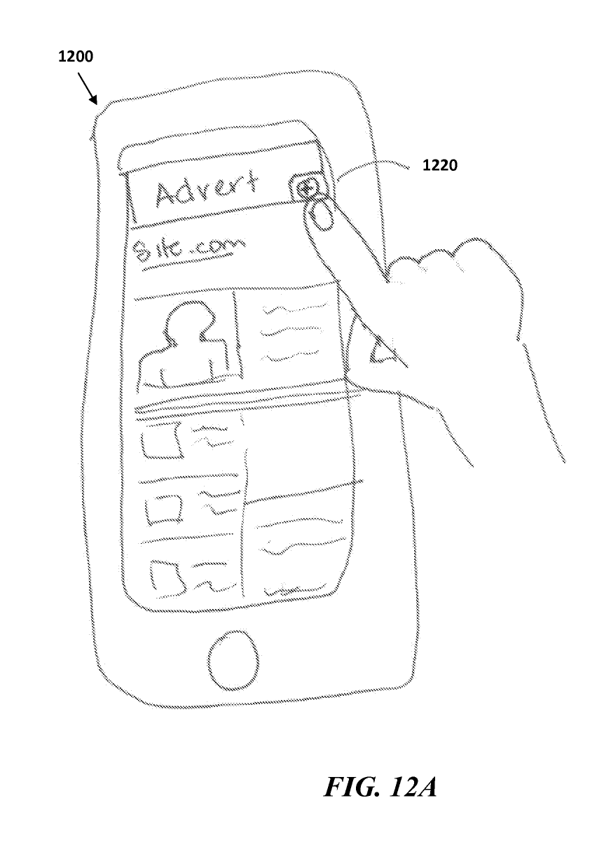

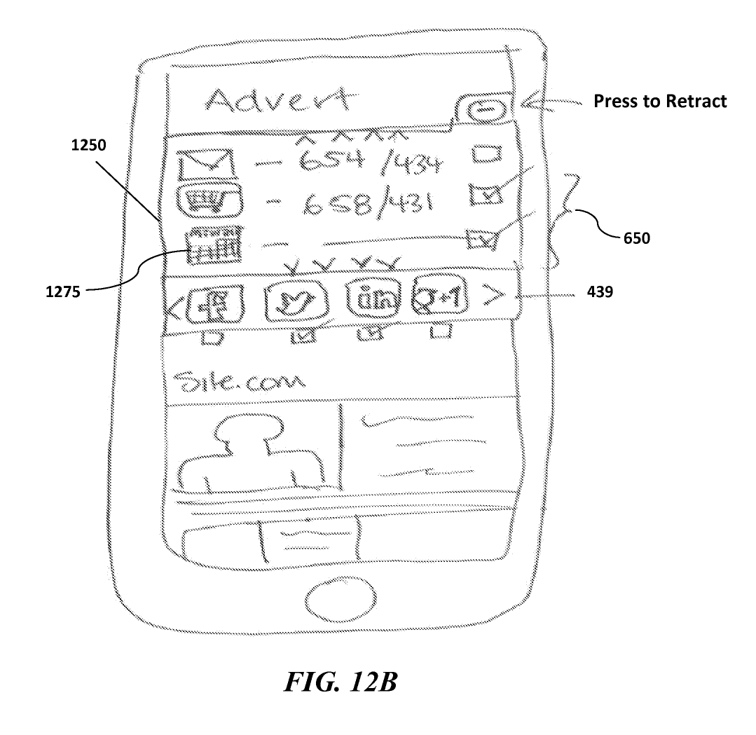

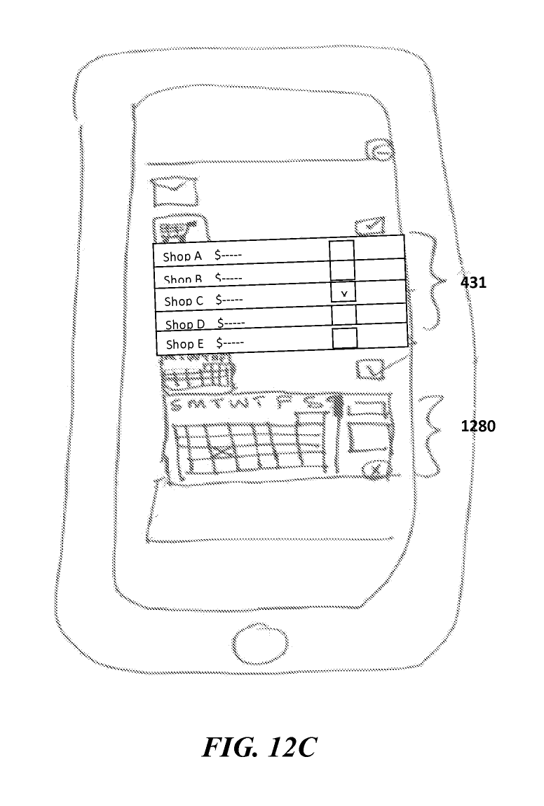

“add to basket”—the user 120 may want to immediately add the item being promoted directly into an electronic shopping basket for retailers that the user 120 has elected to include in his/her user profile 150. FIGS. 12A through 12C provide simplified illustrations of how this works.

“Follow/Watch/more like this/less like this”—the user 120 might want to have opportunities to see more ads or similar ads by the advertiser. It may be that the timing is off, or the user 120 has a brand preference and is open to further advertising by the brand in question. Equally, it may be the user 120 is currently in the consideration phase of a purchase. When the ads 165 are timely and relevant (for example when thinking about a next holiday or car purchase) and they would like to see more ads as a reminder; and when the timing is no longer relevant (they have bought the holiday/car) then they can also choose less ads like this. This will be in keeping with the spirit of the invention whereby the user 120 is declaring that he/she wants to be reminded about a brand's ad 165.

Keeping within the current spirit and scope of the invention, the above list is by no means an exhaustive list and is meant to illustrate the nature of the user 120's desire to capture some or all the essence of an adverting message with digital memories for advertising for the purposes of digitally retrieving or reconnecting in a different time, location, place or method in the future.

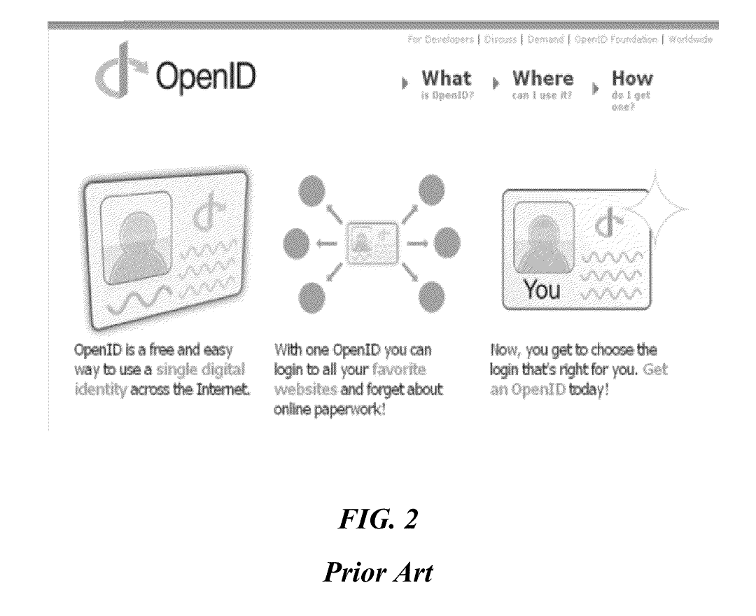

The user profile 150 can be any managed profile, such as OpenID (see FIG. 2). OpenID is a decentralized single sign-on system. Using OpenID-enabled sites, web users have a single digital identity. They do not need to remember multiple usernames and passwords. Instead, they only need to be previously registered on a website with an OpenID “identity provider.” Enabling the use of Open ID would also allow advertisers to take the users directly from the ad to the purchase of the product (without the intermediate steps of registering at the merchant's website etc.), or to enable even 1-click purchase from the ad. The consumer's enablement of how they want to interact with ads is managed by the consumer's profile 150 and what they have selected as ways to interact with an ad as opposed to the ad allowing the functionality.

It should be apparent that OpenID is just one example of a managed profile and that other profiles are contemplated within the spirit and scope of the invention. It should also be noted that the digital memory-backed method does not require a managed profile for its use, as previously discussed. Whatever manner is used to identify the user 120 and set preferences, it needs to be something that easily translates to mobile devices. Not all phones accept flash files and the current coping strategies to save ads for later (click and minimize, screen grab, etc.) do not translate well on mobile devices.

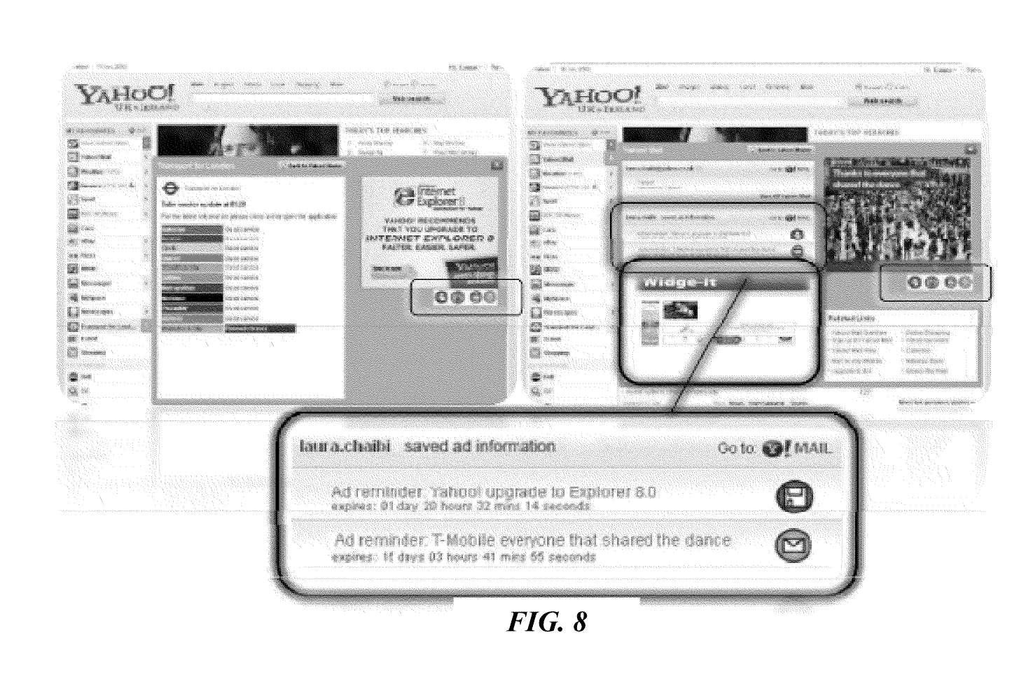

We address this by ensuring that there is no lost data on either platform with icons that are interoperable between the screens (shown in FIG. 8). For example, if you are standing at a bus stop viewing digital media on your mobile device and something that you want to buy comes up in an ad 165, it is unlikely you will click on the ad 165, let alone enter into a purchase transaction; however, you would be likely to send the ad 165 to yourself so you can view it on your PC or other device later . . . or vice versa, something you want to make sure you do not forget you send to your phone after seeing it on your PC.

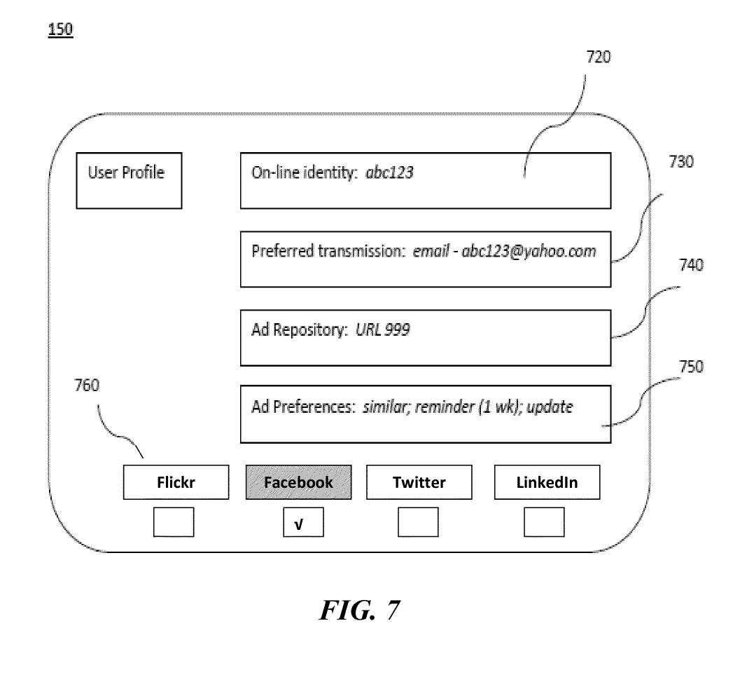

Referring now to FIG. 7 we show an exemplary user profile 150, according to an embodiment of the present invention. The profile 150 contains the user's digital identifier 720 and the preferred mode of transmission for the ads 730. In this case the user 120 has chosen email and provided an email address. The user profile 150 may also include a field 740 to indicate if the user 120 wishes to store ads 165 in an ad repository 160. The user 120 can also provide either an address or a link to the repository 160. The user 120 can also indicate ad preferences 750 such as whether or not to also send ads for similar products (see FIGS. 11A and 11B); whether or not to send reminders for upcoming expirations or offers (and at what rate of time); and whether or not to automatically update any time-sensitive ads 165 when the ad 165 has expired. Other ad preferences 750 are contemplated within the spirit and scope of the invention.

We also include a designation 760 for networking sites so that the user 120 can indicate which, if any, sites should be included in any “ad share” or “follow” or “watch” or “like.” In this example the user 120 has selected Facebook (indicated by a different color and a checkmark).

Flowchart 300.

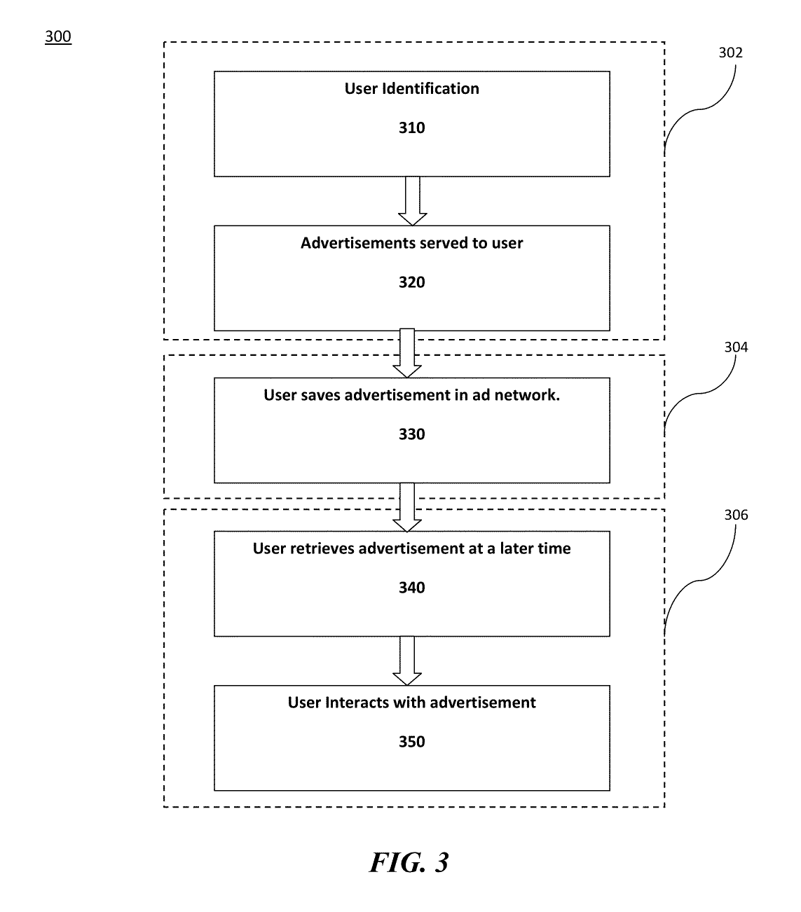

Referring now to FIG. 3 we show a flowchart 300 of a method for digital memory-based advertising according to an embodiment of the present invention. We divide the process into three main sections: Identification of the user 302; saving the relevant ad information for the user 304; and retrieval of saved ad information at 306.

Identification of the User 302.

In step 310 we identify the user 120. An easy way to accomplish this is via a managed profile 150. Another way to identifying a user digitally is through the user's accounts specific to an advertiser/merchant or a web publisher. For example, if the user has an account with amazon.com, we can use the information stored in the Amazon account profile or cookie. Thus, if a user 120 wants to save the ad information corresponding to a particular advertiser/seller, he/she can use the advertiser-specific account for this; or if he/she wants to store the ads 165 she sees on a given publisher's sites, she can use the publisher-specific account for this. Alternatively, a user's email, address, phone contacts, etc. can be used for her identification by the advertiser and the publisher and appropriate methods (as discussed below) can be used for ad storage and retrieval.

Other ways of identifying a user 120 are through his/her accounts specific to an advertiser/merchant or a web publisher. Thus, if a user 120 wishes to save the ad information corresponding to a particular advertiser/seller, he/she can use the advertiser-specific account for this; or if he/she wants to store the ads he/she sees on a given publisher's sites, he/she can use the publisher-specific account for this. The user profile 150 may also be set up to contain details of advertiser/merchant or web publisher accounts to support free flow of information from ad 165 to user profile 150 or ad repository 160 to publisher/merchant site. Alternatively, a user's email, address, phone contacts, and the like can be used for his/her identification by the advertiser and the publisher and appropriate methods (as discussed below) can be used for ad storage and retrieval.

In step 320 the ads are served to the user 120 when the user 120 visits the locations 130A through 130E. The user 120 views the ads and does not have to immediately decide which ad to act on; instead, the user 120 can select multiple ads to save for later.

Saving the Relevant Ad Information for the User—304.

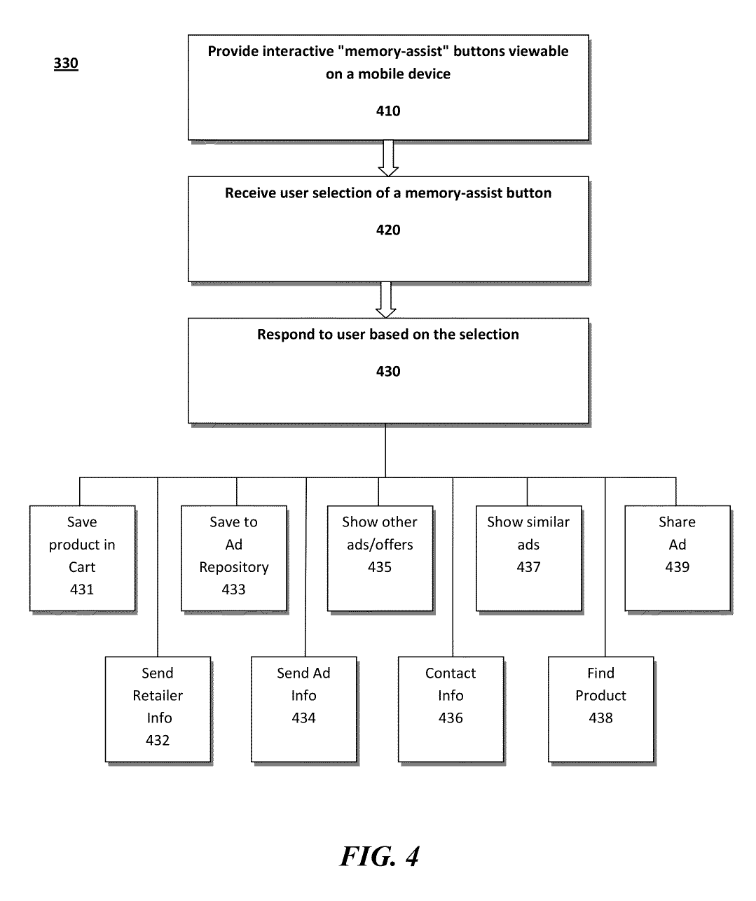

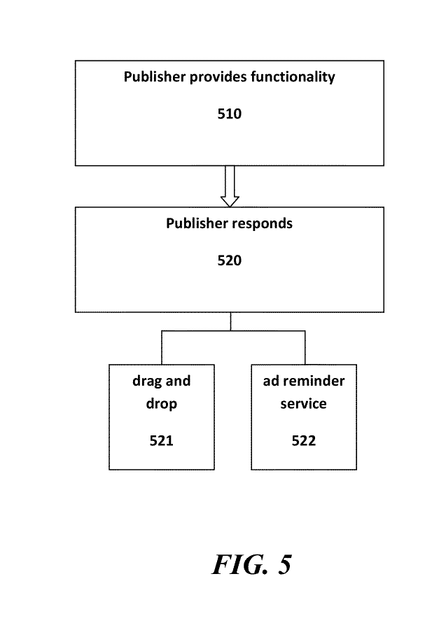

In step 330 the user 120 selects the ad (or ads) 165 to save in the digital repository 160 with the most relevant method appropriate, based on criteria available in the user's profile 150. There are multiple ways to do this and some of these ways will be discussed with respect to FIGS. 4 and 5. At this time the user 120 can also select to “share” the saved ads 165 with those in his/her networking sites such as Facebook. The sharing may be implicit or explicit. Explicitly sharing the ad 165 means that the user 120 makes a selection to share at the time of saving the ad 165 (perhaps by activating a “share” icon). Implicit sharing means that the sharing is done automatically if the user 120 has designated this in his/her profile 150 or if the location in the repository 160 where the ads 165 are stored is set to public.

Retrieval of Saved Ad Information —306.

In step 340 the user 120 is able to retrieve his/her saved ad 165 at a later time and also from a different device than the device used to save the ad 165, if required. For example, a user 120 can peruse sites on a mobile device, save an ad 165, and then later, from a home computer, retrieve the same ad 165. This is because the ad 165 is saved in a repository 160 and only Internet access is required to access it. Interoperability being a key necessity with the current trend in device proliferation.

In step 350 the user 120 interacts with the ad 165. Interaction with the ad 165 can range from simply viewing the ad 165 to making a purchase of the advertised product. Additionally, the user 120 can query the provider for more information about the advertised product. We should note here that the term “product” as used herein refers to any good or service that is sold, communicated, and/or advertised. A product can be clothing, a computer, a television, a facial, a dinner at a restaurant, a ticket to a movie, pet insurance, and many others. We mean to include public information campaigns and charity advertising; advertising in this context defined as “paid for communication.” The user 120 is able to see not only his/her saved ads 165, but also the ads 165 saved by networking contacts if the “share” option is used. This richer information benefits not only the users but also the advertisers as their ads receive the attention of a bigger audience through the implicit “Word of Web” generated by the above system.

Flowchart 400.

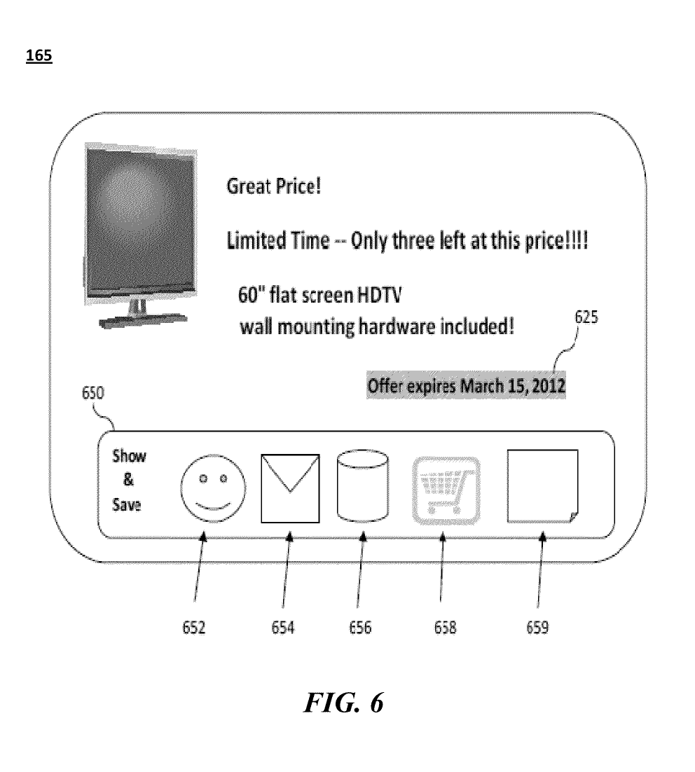

FIG. 4 is a flowchart of methods that advertisers can adopt to save relevant ad information for the users 120. In step 410 an advertiser can provide interactive buttons or icons displayed with the ad 165 (as shown in FIG. 6) that provide various options for the user. These graphical images are displayed in close proximity to the ad 165 or within the ad itself so that there is no doubt that the buttons are related to the ad 165. The graphics used are compatible with mobile and other devices.

In step 420 the advertiser receives a user selection of one of the buttons and in step 430 the advertiser responds based on which icon the user selected. How the user 120 elects to interact with the ad 165 depends on the user's 120 motivation. The options that are presented can be customized according to what the user 120 has selected in his/her profile 150, and accordingly matches functionality that the advertiser has enabled.

Following is a sampling of the possible selections:

Save the product featured in the ad to a shopping cart or basket —431;

Send information about the retailer/supplier —432;

Save the ad or the product information to the ad repository 160-433 (Note: this is the default selection if no specific actions are selected);

Send information about the ad —434;

Show other ads/offers that match the profile —435;

Provide the user's contact information to the supplier of the product —436;

Show ads that are similar to this ad —437;

Provide the closest location of the product featured in the ad —438; and

Share the ad with the user's social connections —439.

It is important to note that the moment a paid advertisement becomes relevant to a consumer, the consumer no longer sees the ad as advertising, but rather as a piece of useful information that needs to be subjectively, implicitly or explicitly classified, stored, pushed into the future (all or in part), retrieved, and/or archived. If archived, it must either expire or be decommissioned. The retrieval of the ad may not take the same form as the original advertisement; it may be that some element(s) of the ad 165 or more information associated with the ad 165 can be transferred.

The storage and retrieval of the ad 165 might be done in its entirety, or parts of: text, image, video, audio, link, thumbnail, search query, the location ad 165 was found, brand name, price, timing, offer duration, offer details, contact details, email address, website address/links, social touch points, components of further information (i.e. recipes, ingredients, etc.) and any other items which one might want to store and retrieve within the spirit and scope of the invention.

User Profile Set Up.

Referring now to FIGS. 11A and 11B, we show an example of how a user 120 is able to set up preferences on his/her user profile 150. FIG. 11A shows that the user 120 can have the option to customize his/her profile 150 or select a default profile. In FIG. 11B we assume the user 120 has selected a Custom set-up. In one embodiment, shown here, the user 120 is presented with a list of options from which to select. Some of the options will have sub-options. For example, if the user 120 selects “Save to Repository” a sub-option may be “set reminder” wherein the user 120 selects a period of time (two weeks, one day, one month) in which to be reminded about the saved item.

Other preference selections may be “send to self” where the user 120 elects to have the ad transmitted to his/her mobile, App, saved search, email, etc. The user 120 may elect to save/send a thumbnail of the ad 165. Additionally, the user may opt to set a Bluetooth-enabled reminder that alerts the user 120 when the user's device is near a location where the product is featured (such as a shop). Call back, sampling sent (auto-complete address); send to other device; email calendar reminder; to do list; electronic post-it note; save coupon for redemption; QR code; save to “wish list.” Those with knowledge in the art will appreciate that these examples are provided for illustrative purposes only and are not meant to limit the invention to the examples shown. It should be noted that the present disclosure does not intend to cover all acts of engaging with an ad 165 with the intent to push things into the future that require future engagement; rather the intention is to cover all modifications, equivalents, and alternatives falling within the spirit and scope of the present invention that enable the ability to turn a moment of interest into future attention.

For the “share” option, the user 120 can enter the address of a person/group to which the saved ad 165 should be sent. The user 120 can specify an email address, Twitter address, phone number, and the like. The options selected here in the profile 150 will translate to selections presented to the user upon activating the ad 165, either by a right-click, or some other means. When the user 120 activates an ad 165, the options selected by the user 120 (or the default options) will appear. The options may appear in a drop-down box, or in some other way.

The user 120 may wish to allow the advertiser to contact the retailer with the user's contact information by selecting the contact option 426. The user 120 may select to have the ad 165 stored in an ad repository 160 that can be shared with others by selecting the ad repository option 423. The user 120 may select to allow the advertiser or retailer to send her alerts about other ads/offers or reminders of the offer by selecting the alerts option 425. The user 120 may ask the retailer to show similar ads by brand/product/or otherwise by selecting option 427.

Should the advertiser be unable to meet the actions the user 120 has enabled (in the profile 150) in order to engage with the ad 165, then those options will not be presented to the user 120. For example, if the user 120 has enabled ‘send me SMS’ and the advertiser has not featured this capability, then the option will not be presented to the user 120. In another possible embodiment, the option will be shown grayed out.

Mobile Device Illustrations of Digital Memories.

Referring now to FIGS. 12A, 12B, and 12C, we show illustrative examples of one way to save/store an ad 165, according to an embodiment of the invention. In FIG. 12A the user 120 views an ad 165 on a mobile device 1200. As discussed with reference to the example of FIG. 6, the ad 165 features an interface 650 with icons shown in close proximity to the ad 165, the interface 650 comprising multiple icons representing the many options for interacting with the ad 165. In this example of FIG. 12A an expandable interactive icon 1220 (a “more” icon) is displayed instead, indicating that more information is available to view on a subsequent screen. This embodiment may be the most useful for small-screen devices such as mobile phones.

FIG. 12B shows the screen after the user 120 has activated the “more” icon 1220 (now a “less” icon). This expanded interaction screen 1250 now features multiple icons 650 (as shown in FIG. 6) that represent multiple ways to store/send the ad 165, along with a choice of locations for storage/sending. This expanded screen 1250 also features social sharing sites 439 where the user 120 is able to “share” his/her ad 165. The social sharing sites 439 are any sites representing a network to which the user 120 and his/her peers belong. An ad reminder service was briefly mentioned in FIG. 5. We show the implementation of that service here. The user 120 selects the icon 1275 representing this feature (icon shown here as a calendar) and is presented with a calendar screen 1280 as shown in FIG. 12C. Here the user 120 is able to select a day in the future to be reminded of the ad 165. Additionally, the user 120 is also able to add a note to self.

Also shown in FIG. 12C is the implementation of element 431 in FIG. 4 (save product in cart). The “shopping cart” icon here is expanded to show the list of establishments that sell/provide the item referenced in the ad 165.

Flowchart 500

Referring now to FIG. 5 we show a flowchart 500 of how web publishers can adopt one or more of the following methods to save relevant ad information for the users. In step 510, in addition to the above-mentioned choices, publishers can also introduce functionalities on their websites that empower the users to save relevant ad information and/or get additional information at their wish. In step 520 the publisher responds to the user's interaction.

For example, publishers can provide an ad repository 160 where users can drag and drop captured ads 521 from anywhere on their websites. Drag and drop can also embody trace, outline/copy, and select all, in the spirit and scope of the invention. This covers touch screen behavior as well as mouse/keyboard behaviors. This repository 160 can be private to a user 120, or if the publisher provides a social networking service, it can be accessible to the user's connections as well. Social sharability of the repository 160 provides users an option to share the ads 165 they see over their social network. The social network can be Twitter, Facebook, Y! mail, Y! messenger, and the like. When a user 120 shares an ad 165 over one of these networks, the ad 165 gets posted/sent as a content to the respective network where the users' (intended) friends can see and interact with this ad 165. The main purpose of social advertising is to enable ad sharing and thus increase the ad reach.

The publishers can also provide an ad reminder service 522 to the users which enables users to opt for ad reminders if they don't have time to explore the ad 165 immediately. These reminders can be implemented by showing the same/similar ad 165 to the user again when she comes back to the publisher's sites, or by sending time-bound email/mobile/calendar/to do list alerts to the users or other means of delivering reminders. If a user 120 chooses to be reminded about an ad 165, she will be shown the same ad 165 whenever she comes back to the publisher's sites, subject to countdown time limits should the saved message expire.

Ad Carousel 900.

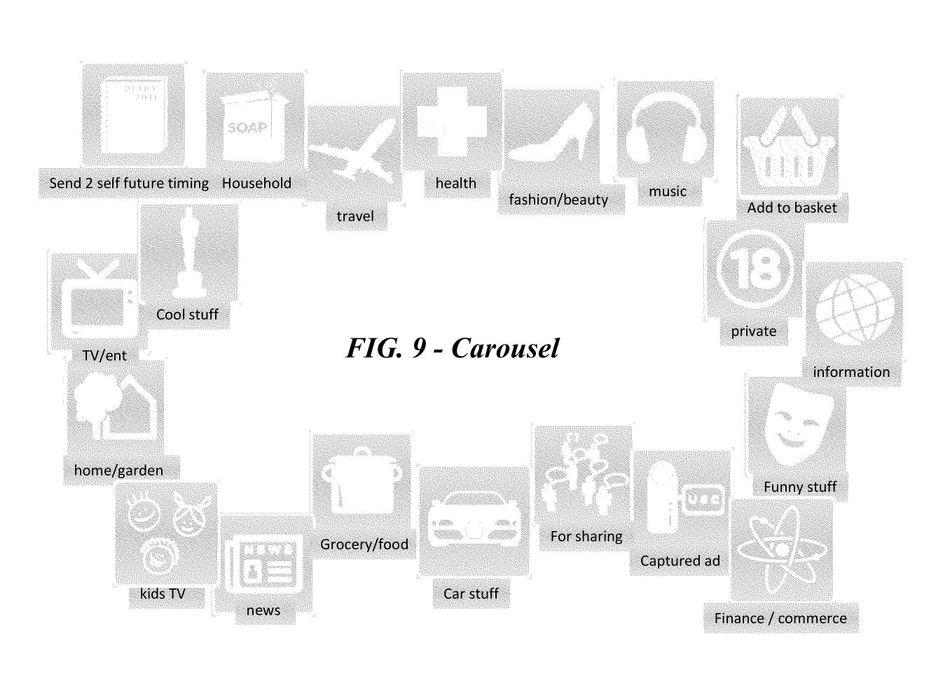

Referring now to FIG. 9, if there are multiple stored ads 165, these ads 165 can be classified or categorized and organized by the user 120 and shown in a carousel, and a separate ad reminder slot may also be dedicated for it. The icons shown in the carousel are based on user preferences much like how we use personal email folders. When a user 120 comes back to a publisher's site, the publisher can also show her other ads 165 that are similar to the one the user likes/wants to be reminded of if the user 120 so wishes. In the carousel of FIG. 9, we show some examples of saved ad categories. This list is by no means exhaustive. The ads 165 can be stored in folders, or in a carousel. Selecting the carousel category can be done by a swipe right/left, using a touch screen with depth into the category. The ad categories can have multiple layers that can be expanded and collapsed, much like the hierarchy common in digital folders.

Each of the many possible ways of saving ad information that are mentioned above also enable users to retrieve the same information at their convenience. For example, if a user 120 saved an ad 165 to his/her private ad repository 160, he/she can access it later by logging into this ad account, or if he/she opted to receive the ad information via email/SMS, or via any other connected device/cloud storage, he/she can find the same through her email/SMS/connected device/cloud later. If the ad 165 was saved to her shopping basket at some seller, she can directly go to that shopping basket when he/she wants, and can buy the respective product.

Apart from the above ways to retrieve a user's saved ads, the advertisers/publishers can also populate the user's ad repository 160 with ads 165 that are similar to the user's saved ads if user 120 has enabled this feature as a preference. This provides the user with richer information from which he/she can benefit while making his/her purchase decisions. If the ad 165 originally saved by the user 120 dealt with a deal that has expired, the advertiser/publisher can update the price/purchase information about that product and/or add similar live deals in the user's ad repository 160; this way the user 120 doesn't have to hunt for the latest live deals. This will have some level of user control settings, such as update with latest offer ON/OFF or timed.

Ad repositories 160 can be “shared.” Publishers who provide social networking services can also provide ad repositories 160 with features where each user 120 can see not only her own saved ads, but also the ads saved by her friends/network. This richer information benefits not only the users but also the advertisers as their ads 165 get attention of a bigger audience through the implicit “word of WEB” generated by the above system. The user 120 can also prioritize friends/networks/groups to surface more relevant/important items implicitly or explicitly within the spirit and scope of the invention.

Interface 650.

Referring now to FIG. 6 we show an exemplary illustrative ad 165 with a memory-assist interface 650 that allows a user 120 to customize his/her interaction with the ad 165. As is common with many digital ads 165, this one shows a digital image of the product, along with a brief description of the product and/or the “deal.” This ad 165 also shows a temporal component 625: “Offer expires Mar. 15, 2012.” This expiry information 625 needs to be saved along with the other information for the ad 165.

We provide memory-assist buttons 652, 654, 656, 658, and 659 that are displayed in close proximity to the identifying image for the ad 165. The memory-assist buttons are graphical images, or icons, that provide more options for user involvement with the ads 165. The user 120 is able to select from among the buttons to customize his/her interaction with the ad 165. For example, the user 120 may want to share 652 the ad 165 with contacts within a social network. Or, the user 120 may elect to have information about the ad 165 emailed 654 to the user 120 or sent by SMS or other devices.

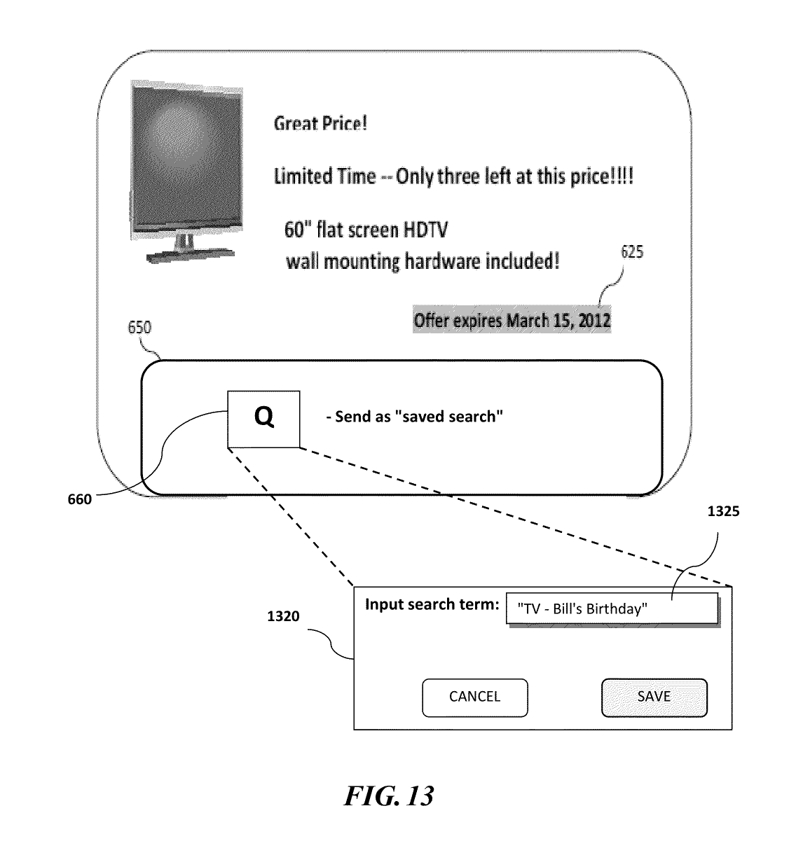

Another option is to have the ad 165 stored in an ad repository 160 or saved in a shopping basket 658 at a preferred seller. The user 120 may also select to have information 659 about the product/retailer stored or sent. Another option 660 allows the user 120 to send the ad 165 as a “saved search” which can be retrieved at repository 160 where user 120 defines the statement applied to the ad 165, such as “Ella's birthday present.” An example is shown in FIG. 13, where the user 120 has selected option 660. This selection triggers presentation of another user interface 1320 providing an input text box 1325 for the user 165 to enter his/her statement reminder. This can be a keyword and/or a phrase that will remind the user 120 why he/she saved this ad 165. In this example shown in FIG. 13, the user 120 has entered “TV—Bill's Birthday.” This search term will be stored along with the ad 165 in the repository 160.

Additionally, the user 120 may select to request the location (store, office, bank, mall) where the product featured in the digital ad 165 can be found. Using the geo-location capabilities found in most portable devices today, and/or the geographical location data from the user profile 150, the user 120 can be directed to the product in closest proximity to the user 120. For example, if the digital advertisement 165 features a very favorable mortgage loan refinancing rate at ABC Bank, the user 120 can select to receive information on the ABC Bank closest to the user 120.

Benefits and Advantages.

The proposed methods for using digital memory for advertising have the following advantages:

1) They provide the users more control over how they want to interact with and remember ads, or not forget ads.

2) They prevent the frustration users experience due to the lack of time to interact with ads or the inappropriate time when the ads are shown to them, or due to the waste of their time searching for the lost ads afterward.

3) Because of ad storage and retrieval at a user's convenience, it will bring more user attention and increased user interaction with ads and hence will result in better ad campaign effectiveness.

4) Because of enhanced overall digital advertising experience, it will bring more user engagement for the publishers.

Unlike social advertising, the main objective of digital memory-based advertising is to enable users to save and retrieve ads for their own use. By harnessing the social sharability of ads mentioned above, a user can forward an ad to herself, or others, thereby making it accessible for later reference.

### Hardware Embodiment

As will be appreciated by one skilled in the art, the present invention is device agnostic and may be embodied as a system, method or computer device program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, or linked by Quick Response (QR) code, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

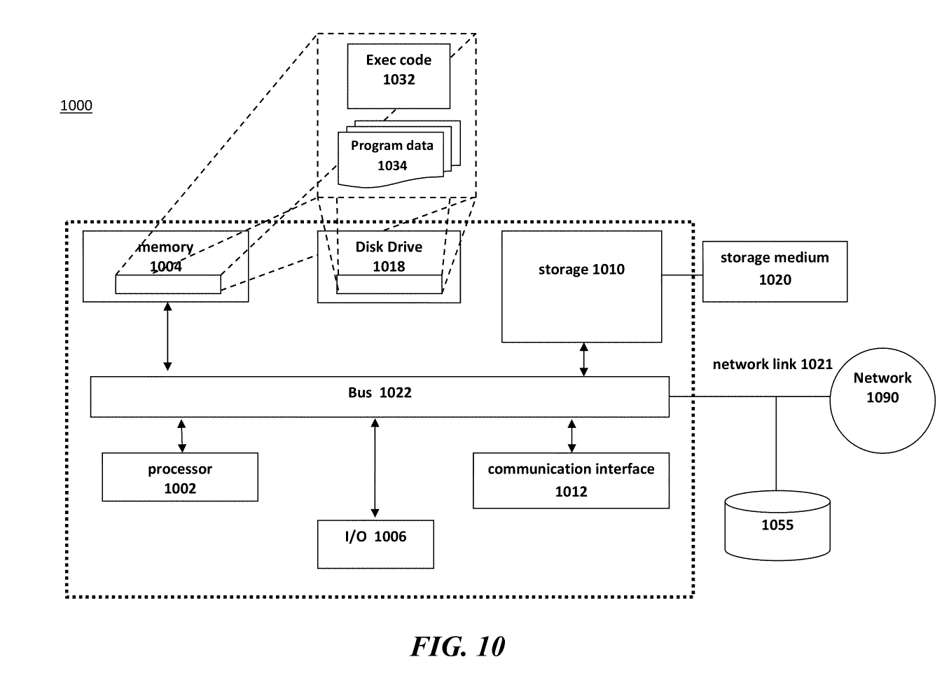

Referring now in specific detail to the FIG. 10, there is provided a simplified high-level block diagram of an information processing system 1000 for digital memory-backed advertising in which the present invention may be implemented. For purposes of this invention, computer system 1000 may represent any type of computer, information processing system or other programmable electronic device, including a client computer, a server computer, a portable computer, an embedded controller, a personal digital assistant, mobile device, Internet TV, and the like. The computer system 1000 may be a stand-alone device or networked into a larger system. Computer system 1000, illustrated for exemplary purposes as a networked computing device, is in communication with other networked computing devices (not shown) via network 1090. As will be appreciated by those of ordinary skill in the art, network 1090 may be embodied using conventional networking technologies and may include one or more of the following: local area networks, wide area networks, intranets, public Internet, Cloud computing, and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 1000, for simplicity. As will be appreciated by those of ordinary skill in the art, aspects of the invention may be distributed among one or more networked computing devices which interact with computer system 1000 via one or more data networks such as, for example, network 1090. However, for ease of understanding, aspects of the invention have been described as embodied in a single computing device—computer system 1000.

Computer system 1000 includes processing device 1002 which communicates with an input/output subsystem 1006, memory 1004, storage 1010 and network 1090. The processor device 1002 is operably coupled with a communication infrastructure 1022 (e.g., a communications bus, cross-over bar, or network). The processor device 1002 may be a general or special purpose microprocessor operating under control of computer program instructions 1032 executed from memory 1004 on program data 1034. The processor 1002 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 1004 may be partitioned or otherwise mapped to reflect the boundaries of the various memory subcomponents. Memory 1004 may include both volatile and persistent memory for the storage of: operational instructions 1032 for execution by processor device 1002, data registers, application storage and the like. Memory 1004 preferably includes a combination of random access memory (RAM), read only memory (ROM) and persistent memory such as that provided by a hard disk drive 1018. The computer instructions/applications that are stored in memory 1004 are executed by processor 1002. The computer instructions/applications 1032 and program data 1034 can also be stored in hard disk drive 1018 for execution by processor device 1002. Database 1055 pictured here is a representation of storage for the feedback data, producer data, and consumer data and may be a plurality of databases operably coupled with a server network 1090 such as the Internet through network link 1021.

Those skilled in the art will appreciate that the functionality implemented within the blocks illustrated in the diagram may be implemented as separate components or the functionality of several or all of the blocks may be implemented within a single component. The I/O subsystem 1006 may comprise various end user interfaces such as a display, a keyboard, and a mouse, touchscreen or otherwise. The I/O subsystem 1006 may further comprise a connection to a network 1090 such as a local-area network (LAN) or wide-area network (WAN) such as the Internet or Cloud.

The computer system 1000 may also include storage 1010, representing a magnetic tape drive, an optical disk drive, a CD-ROM drive, Cloud storage, and the like. The storage drive 1010, which can be removable, reads from and/or writes to a removable storage unit 1020 in a manner well known to those having ordinary skill in the art. Removable storage unit 1020, represents a floppy disk, a compact disc, magnetic tape, optical disk, CD-ROM, DVD-ROM, etc. which is read by and written to by removable storage drive 1010. As will be appreciated, the removable storage unit 1020 includes a non-transitory computer readable medium having stored therein computer software and/or data for implementing the real-time feedback collection system.

The computer system 1000 may also include a communications interface 1012. Communications interface 1012 allows software and data to be transferred between the computer system and external devices. Examples of communications interface 1012 may include a modem, a network interface (such as an Ethernet card), a communications port, a PCMCIA slot and card, machine to machine, device to device, etc. Software and data transferred via communications interface 1012 are in the form of signals which may be, for example, electronic, electromagnetic, optical, or other signals capable of being received by communications interface 1012.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for digital advertising, said method comprising:
using a memory device with computer-executable instructions stored therein, said computer-executable instructions comprising:
accessing a profile identifying a user, said profile providing said user's preferences for interaction with a digital advertisement;
receiving a selection of the digital advertisement served to the user; and
storing at least a portion of the selected digital advertisement in a digital ad repository linked with the user's profile, said storing executed according to the user's preferences; and
using a processor device operably coupled with the memory device, said processor device executing the computer-executable instructions from memory.

2. The method of claim 1 wherein storing the at least a portion of the selected digital advertisement comprises saving data about a product featured in said selected digital advertisement.

3. The method of claim 1 wherein accessing the profile with the user's preferences for interaction comprises accessing a preferred mode of transmission for the at least a portion of the selected digital advertisement.

4. The method of claim 1 further comprising:
generating first interface responsive to receiving the selection of the digital advertisement; and
presenting the first interface comprising memory-assist graphical images in close proximity to the selected digital advertisement served to the user, said memory-assist graphical images providing a plurality of advertisement interaction options to the user.

5. The method of claim 4 further comprising:
responding to the user's selection of one of the memory-assist graphical images by performing an action selected from a group consisting of:
saving data about a product featured in the digital advertisement in a digital shopping cart,
sending data about a retailer featured in the advertisement,
saving to the ad repository,
sending information about the ad,
providing other ads/offers similar to this one,
providing locations in close proximity to the user where the product can be found;
providing contact information,
sharing the selection with the user's social connections,
providing an input for a value facilitating a future search query, and
setting a reminder.

6. The method of claim 4 wherein the memory-assist graphical images that are displayed correlate to the user's preferences from the user profile.

7. The method of claim 1 wherein storing the at least a portion of the selected digital advertisement comprises performing a drag-and-capture into the ad repository.

8. The method of claim 1 wherein storing at least a portion of the selected digital advertisement in the ad repository comprises:
presenting a plurality of locations within the digital ad repository, each of the plurality of locations designated by a category heading; and
saving the selection to at least one of the plurality of locations based on the user's category choice.

9. The method of claim 1 further comprising:
monitoring the stored selection;
determining if the stored selection comprises an expiration date; and
updating the selection when the expiration date is reached.

10. The method of claim 9 further comprising:
sending reminders to the user about upcoming expirations.

11. The method of claim 5 wherein providing an input for the value facilitating the future search query comprises:
presenting a second user interface comprising an input form field;
accepting the user's value in the input form field; and
saving the user's value along with the selected digital advertisement in the digital ad repository.

12. An information processing system for digital advertising comprising:
a memory device with computer-executable instructions stored therein, said computer-executable instructions causing a computer to perform:
accessing a profile identifying a user, said profile providing said user's preferences for interaction with a digital advertisement stored in a digital ad repository linked with said profile;
receiving a selection of a digital advertisement served to the user; and
storing at least a portion of the selected digital advertisement in the digital ad repository linked with the user's profile, said storing executed according to the user's preferences; and
a processor device operably coupled with the memory.

13. The information processing system of claim 12 further comprising:
the digital ad repository.

14. The information processing system of claim 12 wherein the computer-executable instructions further comprise:
generating a first interface responsive to receiving the selection of the digital advertisement; and
presenting the first interface comprising memory-assist graphical images in close proximity to the digital advertisement, said memory-assist graphical images providing a plurality of advertisement interaction options to the user.

15. The information processing system of claim 14 wherein the computer-executable instructions further comprise:
responding to the user's selection of one of the memory-assist graphical images by performing an action selected from a group consisting of:
saving data about a product featured in the digital advertisement in an digital shopping cart,
sending data about a retailer featured in the advertisement,
saving to the ad repository,
sending information about the ad,
providing other ads/offers similar to this one,
providing locations in close proximity to the user where the product can be found;
providing contact information,
sharing the selection with the user's social connections,
providing an input for a value facilitating a future search query, and
setting a reminder.

16. The information processing system of claim 14 wherein the memory-assist graphical images that are displayed correlate to the user's preferences from the user profile.

17. The information processing system of claim 12 wherein storing the at least a portion of the selected advertisement comprises performing a drag-and-capture of the digital advertisement into the ad repository.

18. The information processing system of claim 12 wherein the computer-executable instructions further comprise:
monitoring the stored selection;
determining if the stored selection comprises an expiration date; and
updating the selection when the expiration date is reached.

19. The information processing system of claim 18 wherein the computer-executable instructions further comprise:
sending reminders to the user about upcoming expirations.

20. The information processing system of claim 12 wherein storing at least a portion of the selected advertisement in the ad repository comprises;
presenting a plurality of locations within the digital ad repository, each of the plurality of locations designated by a category heading; and
saving the selection to at least one of the plurality of locations based on the user's classification choice.

21. The information processing system of claim 12 wherein retrieving the stored selection occurs on a different device than storing the selection.
